(19) United States
(12) Patent Application Publication
(10) Pub. No.: US 2006/0149432 A1
(43) Pub. Date: Jul. 6, 2006

(54) Flight Management Architecture and Design Methodology

(76) Inventor: John A. Robinson, Phoenix, AZ (US)

Correspondence Address: ELLIS & VENABLE, PC, 101 NORTH FIRST AVE., SUITE 1875, PHOENIX, AZ, 85003, US

(21) Appl. No.: 10/905,404

(22) Filed: Jan. 3, 2005

(51) Int. Cl. G06F 17/00

(52) U.S. Cl. 701/3; 701/200

(57) ABSTRACT

A FMS architecture and design methodology wherein the critical system functions are implemented in substantially autonomous partitions. The FMS architecture and design methodology enhances system cohesiveness and reduces data coupling relative to existing FMS designs. Execution and control of the FMS is governed by central operating system and complex areas of the traditional FMS organization are structured into these manageable partitions. Finally, data items, whether singular data units or large data structures, are restricted from being nonchalantly passed between functional areas to deter data coupling between FMS function areas.

### FIELD OF THE INVENTION

The present invention is generally related to the field of aviation and more particularly to the field of flight management systems and flight management architectures.

### DISCUSSION OF THE RELATED ART

The primary function of any Flight Management System (FMS) is the planning, navigation, guidance and control of the aircraft based on the reception and feedback of the pilot and additional aircraft systems. The functions of an FMS have grown from a simple navigation system to a dual operation system that is essential to flight deck operational procedures. As a result, pilots today rely on the FMS to provide timely and correct flight planning, navigation, guidance, control and annunciation. The traditional FMS employs the following high-level functions: Input/Output (I/O), Control and Display Unit (CDU), Navigation (NAV), Lateral Guidance (LG), Vertical Guidance (VG), Electronic Instrument System (EIS), Performance (Perf), Built In Testing (BIT), and Operating System (OS).

The design of an FMS is a challenging endeavor. The FMS is a large software-based system with numerous, complex and intricate functions. The existing aircraft market requires a quick cycle time of products exhibiting quality at interim delivery points as well as final delivery. Yet, FMS quality degrades due to undisciplined or nonexistent system planning, data organization and system structure. A common trait of poorly planned FMS designs is low system cohesion. Low system cohesion means that one or more of the functional areas identified above take on system responsibilities that are logically mapped to the operating system or other functional areas. Systems characterized by low cohesion are difficult to modify, maintain and reuse because the ripple effects of a single change to the system are rarely completely understood and often result in the creation of additional unforeseen problems. This reduces confidence in the product and in the engineering organization that produced the FMS.

For example, in the traditional FMS design the CDU function is extremely large and cumbersome and difficult to maintain or modify. The primary responsibility of the CDU function is to gather input data from the pilot and to display output data to the pilot via the CDU. The CDU includes software modules and data are numerous and unwieldy making ripple effect analysis difficult. Further, data coupling for this function has been traditionally extremely high. Commonly, a large amount of data is passed to the CDU, aliased, and then passed on again throughout the CDU. The CDU not only performs its basic function, but also often takes on additional responsibilities.

In addition to its basic function, the CDU often provides a majority of FMS flight planning. The CDU generates a three-dimensional flight plan using three-dimensional data and complex performance equations. The generation of the flight plan is a complex task and monopolizes a shared data buffer, which is also used by many functional areas to write and read flight-planning data. Predictably, the system bogs down and experiences data access contention issues when multiple functional areas require access to this data buffer. The CDU is often also used for data interpretation, manipulation and timing coordination and further executive control and timing for tasks that also results in timing delays associated with signal and wait commands.

Another problem with the traditional FMS design is the manner in which data is treated. There is often little effort to reduce data coupling between function areas. Chief among these problems is that the traditional flight plan consists of a tightly coupled data structures comprising coordinates in three-dimensional flight space. The use of data buffering techniques means that functions must wait for access to high-use data, such as guidance data, while the data buffer is being updated with the flight plan or flight plan data. Further augmenting the problem is the likelihood that several functional areas will request access to the buffer for a given update. The result is a slowing of overall system response while functions wait for their “turn in the barrel” with the flight data or flight plan. Similar system cohesion and data coupling problems extend to other functional areas.

The Performance (Perf) functional area's basic responsibility is to provide calculations based on aircraft performance characteristics to other FMS functions. In the traditional FMS structure, the Perf functional area is large, cumbersome and difficult to manage. The traditional structure does not minimize data coupling to reduce module complexity; data specific to the airframe and engine is embedded into mathematical calculation units restricting the calculation units from reuse. Moreover, a large amount of flight planning is traditionally done within the Performance function, specifically in the vertical plane. Thus, the Perf functional area must contend for access to the data buffers used by CDU and VG, causing lockout of other functions and slower system response. It follows that system cohesion for the Perf functional area is traditionally low.

The Input/Output (I/O) functional area's basic responsibility is to implement interface control; to decode data from input busses and analog circuitry, determine its validity, and place them into variables for use by other functional areas and; to format data for the output busses. The traditional I/O functional area also takes on more responsibility than that which is mentioned above. For example, the I/O functional area often performs calculations and decision making with respect to data values which are retrieved from an input bus or are to be placed on an output bus.

The Lateral Guidance (LG) functional area's basic responsibility is to guide and control the aircraft along the flight plan. FMS lateral guidance systems have contained both closed-loop and outer-loop control commands to accomplish these goals. In the traditional FMS organization, LG takes on the additional responsibility of a portion of flight planning via access to the data buffer used by CDU and display functions for EIS. Since the guidance functions run at a fast rate in the foreground, data aliases are created while waiting for access to the data buffer, or waiting for new data to be placed into the data buffer. Using data aliases creates even higher data coupling and potential corruption due to timing considerations. Further, the EIS function is often incorporated into the LG.

The Vertical Guidance (VG) functional area's basic responsibility is to guide and control the aircraft with respect to altitude targets, speed targets, vertical speed targets and the descent path. FMS vertical guidance systems have contained both closed loop and outer-loop control commands to accomplish these goals and is prioritized by the FMS. In the traditional FMS organization, the vertical guidance functional area takes on the additional responsibility of interaction with the descent path while in the descent flight phase, and interpretation of altitude targets and speed targets in the climb and cruise phases. This type of interpretation requires the use of lengthy mathematical functions that need not be processed in the foreground at a fast rate. Access to the descent path resource, originated by Perf, is contentious when VG computes descent path data. Timing problems occur when VG aliases data due to lack of access.

The Navigation functional area's basic responsibility is to determine both the position of the aircraft relative to the earth (latitude and longitude) as well as the position of the aircraft above the earth (altitude). The traditional activities necessary to determine this data are radio tuning, magnetic variation, and aircraft velocity and wind velocity computations. In the traditional organization, the Navigation functional area often must wait for access to the data buffer used by CDU, or lock out other functions while accessing the data buffer.

The Operating System functional area's basic responsibility is to provide the interface to computing hardware and management of space and time resources to other FMS functional areas. In the traditional FMS organization, the Operating System functional area has extremely low system cohesion. The functional area has supported the low level routines necessary for task dispatch; delay processing, and signal and wait routines. Further, a great portion of the task scheduling duties is done from within the functional areas themselves. Over time, control of the system has been lost though the development of independent scheduling routines as mentioned in the description of the above functional areas.

Thus, the FMS progressed from the simple supplemental navigation system to include flight planning and ground referenced guidance. Aircraft performance calculations and construction of a descent path for three-dimensional guidance resulted. Each addition to functionality was built with a shifting set of requirements as each function was developed as a working prototype. Thus, the traditional FMS started as a prototype and progressed by adding additional prototype functions. The shifting requirements of the Flight Management System have prevented the definition of complete system functionality and comprehensive architectures have not been applied to FMS functions based on system engineering principles. The FMS has traditionally been a working prototype of the air framer's and fleet operator's unstable requirements. It is therefore common to see FMS systems that are large integrated software systems designed for a particular design objective. The system concepts are desirable and workable; however, the implementation is costly and does not lend itself to easy modification. Additionally, as customer functional requirements and regulatory agency requirements grew, it was often believed that the solution to a large number of FMS growth problems was to provide new hardware (faster processor, better mass storage, more memory, etc . . . ). While these upgrades are important to the system as a whole, they do not address some of the fundamental structural problems in traditional FMS system software.

The existing generation of FMS is unorganized and unstructured, which makes productive modification difficult. The difficulty in system modification feeds on itself as structural breakdown occurs. Structural breakdown occurs when new requirements, which are not accurately mapped to the functions that should perform the task, are added to the system. As it now stands, requirements are often mapped to a functional area based on the execution time of the functional area, or to a functional area based on the ease of implementation at the time that a problem is discovered. In short, the nature of the function to be performed and its relationship to other functions is often an afterthought or not considered at all. It is clear that there remains substantial room for improvement in the design of Flight Management Systems.

The basic functions of the FMS are now mature and established. While newer methods of gathering data used within the FMS, communicating FMS generated data, or performing FMS basic functions may be found, the fundamental requirements of the FMS shall remain constant for some time. A need is present for a FMS architecture that organizes flight management functions into an architectural structure that is logically associated with the FMS fundamental requirements.

Finally, the system architecture described is for illustrative purposes only and is not intended to imply that the method or apparatus of the present invention to be described in the disclosure below is limited to any particular architecture. In light of the disclosure that follows, it is within the knowledge of an ordinarily skilled practitioner to modify the method and device of the present invention for alternate system architectures.

### SUMMARY OF THE INVENTION

Disclosed is a FMS architecture and design methodology wherein the apparatus is partitioned and arranged in a manageable, cohesive and coherent fashion based on mission principles. The disclosed FMS architecture and design methodology shall allow a controlled coupling of data between system partitions. The FMS functions shall be partitions exhibiting increased cohesiveness and reduced data coupling relative to existing FMS designs. Execution and control of the FMS is governed by a central operating system and the most complex areas of the traditional FMS are structured into these cohesive, manageable partitions. Finally, data items, whether singular data units or large data structures, are restricted from being nonchalantly passed between functional areas to deter increased data coupling between FMS function areas.

One aspect of the disclosure comprises the organization of a flight management system including an operating system on a computing platform that interfaces with a lateral flight planning partition that constructs a lateral flight plan within a first two-dimensional plane, and a vertical flight planning partition that constructs a vertical flight plan within a second two-dimensional plane. The preferred lateral and vertical flight planning partitions are embodied in autonomous, partitioned software modules that generate distinct lateral and vertical flight plans that are made available to lateral and vertical guidance partitions, respectively.

Another aspect of the disclosure comprises a method of managing computer memory including the creation of data partition areas within a portion of the computer memory defined by rules limiting the read and write privileges of the data partition. The rules limiting the read and write privileges govern what data can be written to the data partition areas and restrict access to said data partition areas preferably to no more than two autonomous flight management system functions that commonly exchange a significant quantity of data.

Another aspect of the disclosure comprises a method of developing a flight plan in a flight management system, comprising permitting flight management software functions within the flight management system access to flight data within a previously developed first flight plan while denying said flight management software functions access to flight data within a second flight plan undergoing development. Access by said software functions to said second flight plan is subsequently permitted upon its completion. These and other aspects of the invention will become apparent when the disclosure and claims of the application are considered together as a whole. The inclusion or absence of mention in this section does not convey any intended limits to the scope of the invention.

### BRIEF DESCRIPTION OF THE DRAWINGS

The figures or drawings together with the description of embodiment(s) serve to explain the principles or concepts of the disclosure and are not intended to be limiting. Ordinarily skilled practitioners in the art could conceive of modifications or equivalents of the disclosed embodiments.

FIG. 1 illustrates a conceptual model of the FMS of the disclosure and preferred system partitions;

FIG. 2 illustrates a conceptual model of a preferred manner of communicating between system partitions and connected aircraft controls and operator input devices;

FIG. 3a illustrates a conceptual block diagram of partitions of the FMS of the disclosure involved in vertical flight planning;

FIG. 3b illustrates a conceptual block diagram of partitions of the FMS of the disclosure involved in lateral flight planning;

FIG. 4a illustrates an representative vertical flight plan constructed according to the FMS of the disclosure;

FIG. 4b illustrates an representative lateral flight plan constructed according to the FMS of the disclosure;

FIG. 5a illustrates a timing diagram of the operable states of the vertical flight planning partition before during and after the construction of a vertical flight plan;

FIG. 5b illustrates a timing diagram of the operable states of the lateral flight planning partition before during and after the construction of a lateral flight plan;

FIG. 6 illustrates a conceptual model of an FMS implementing a partition data area.

FIG. 7a illustrates a conceptual block diagram of an FMS embodiment implementing vertical flight planning with partition data areas (not shown is the PERF 160 and an VFPPERF partition area associated with the VFP 110 and the PERF 160); and

FIG. 7b illustrates a conceptual block diagram of an FMS embodiment implementing lateral flight planning with partition data areas (not shown is the PERF 160 and an LFPPERF partition area associated with the LFP 110 and the PERF 160).

### DISCUSSION OF PREFERRED EMBODIMENTS

One or more preferred embodiments of the Flight Management System summarized above are described below. The embodiments are illustrative in nature and convey the concepts and nature of the invention(s) disclosed herein and are not intended to be limiting as to scope. The claims at the end of this description are more fully indicative of the scope of the invention

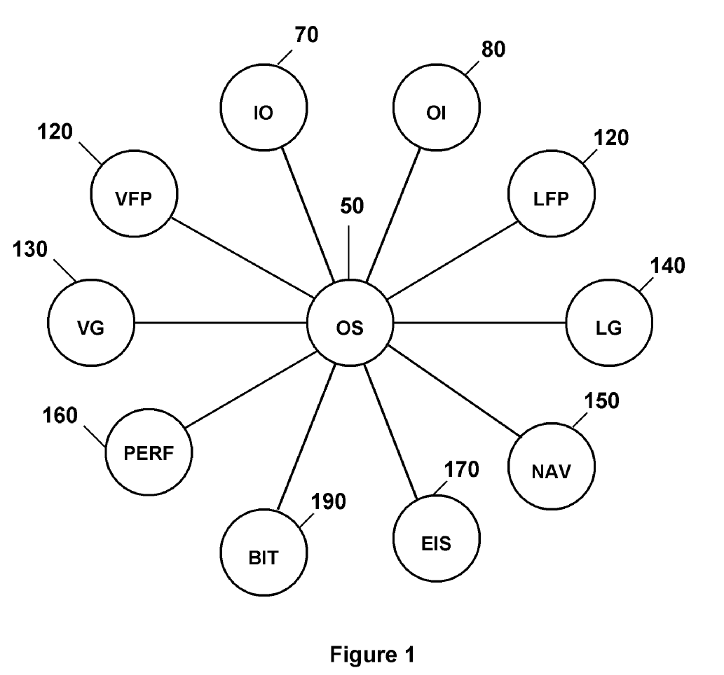

Towards the fulfillment of traditional flight management system functions or requirements, the Flight Management System (FMS) 10 disclosed herein comprises, an Operating System (OS) 50, an Input Output partition (IO) 70, an Operator Interface partition (OI) 80, Vertical Flight Planning partition (VFP) 110, a Lateral Flight Planning partition (LFP) 120, a Vertical Guidance partition (VG) 130, a Lateral Guidance partition (LG) 140, a Navigation partition (NAV) 150, a Performance partition (PERF) 160, a Maintenance partition (MAINT) 180, a Built in Test partition (BIT) 190 and an Electronic Instrument System partition (EIS) 170. The partitions are embodied in software operable on computer hardware and form a computing platform for control of an aircraft. Each partition disclosed in the embodiment(s) below is conceptually illustrated as interfacing with the OS 50 in FIG. 1. FIG. 1 emphasizes that preferred embodiments of the FMS 10 architecture and design methodology provide a separate system partition for the FMS partitions listed above. Preferred embodiments of the FMS 10 partitions emphasize object oriented programming principles or implement the above described partitions as autonomous functions that may be called from other partitions or the OS 50.

Poorly designed software systems are often described as having excessive “data coupling.” This implies that an unnecessarily large amount of data is passed between different system functions that operate on that data. A related concept is “system cohesion.” Systems having low system cohesion are generally characterized by at least one software unit (module, object, task, etc . . . ) designed to perform two or more distinct logical functions. Systems characterized by excessive data coupling and low system cohesion are difficult to maintain due to interdependencies between software units. Said systems are also difficult to reuse or modify for other applications. Contrarily, reusable and maintainable software systems minimize data coupling and maximize system cohesion. An FMS 10 designed according to the architecture and methodology disclosed herein is structured to minimize data coupling and maximize system cohesion.

The preferred FMS software architecture exhibits a kernel, a shell, and an outer skin. The kernel will be modified when major system changes occur with respect to the priority and/or scheduling of partitions in the system. The shell will be modified when there are moderate modifications necessary to the interfaces between the partitions. The outer skin will be modified for specific, customer driven requirements for the given aircraft flight deck interface requirements or airframe and engine performance data. Since the partitions in this architecture are nearly autonomous, altering the specific requirements of any partition will become minor modifications. It follows that FMS 10 modifications and maintenance can occur efficiently because the scope of the work is known and limited by the FMS 10 architecture.

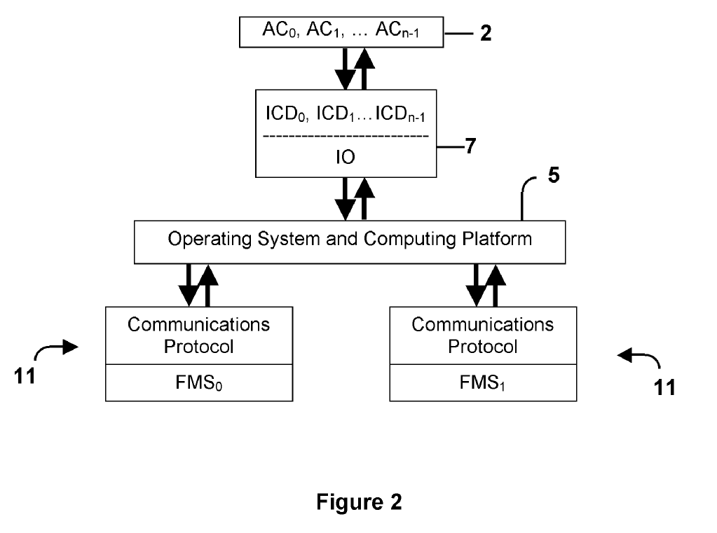

FIG. 2 illustrates a conceptual block diagram of a preferred interfacing methodology described herein. Each FMS system partition 11 comprises software executing a distinct FMS function and also embedded code implementing the appropriate communications protocol for its intended interface(s). Communications between two or more FMS system partitions 11 comprises interfacing using the Operating System and Computing Platform 5. Communications between an FMS system partition 11 and aircraft control 2 (e.g. operator interface device, engines, airframe, etc.) comprises interfacing using the Operating System and Computing Platform 5 and the IO 7.

As conveyed by the illustration, an Interface Control Document (ICD) that defines the communication medium and communications protocol for each interface of an FMS partition 11 and a connected aircraft control 2 may govern each distinct interface. ICDs may be provided on a one-for-one basis (i.e. each partition interface and aircraft control has a separate ICD) to promote cohesion in the interfaces, or alternatively, a single ICD may implement one or more interfaces with aircraft control 2. Each partition 11 of the preferred FMS 10 performs its specified calculation or operation thereby generating data for the destination partition 11 or the aircraft control 2. In some circumstances the partition 11 also delivers a validity indicator that is to be transmitted to the destination partition 11 or to the connected aircraft control 2. Validity indicators are used by some protocols to ensure data freshness and correctness.

FIG. 2 illustrates two partitions 11 coupled via the Operating System and Computing Platform 5. As an example, the first partition (i.e. FMS₀) 11 is a vertical guidance partition that interfaces with connected aircraft control 2 using the IO 7; and the second partition 11 (i.e. FMS₁) is a flight planning partition that interfaces with the first partition (i.e. FMS₀) 11. The IO 7 has the responsibility of implementing and controlling the interface between the first partition (i.e. FMS₀) 11 and the aircraft control 2. Interface control comprises decoding data from connected aircraft control 2 delivered by hardware busses and analog circuitry, determining the validity of the input/output data, signal conditioning and data formatting for data to be output on busses or other media to connected aircraft control 2, and routing of input data for use by other partitions 11. According to the example and the description above, the flight planning partition (i.e. FMS₁) generates a flight planning output to the vertical guidance partition (i.e. FMS₀) according to an intra FMS 10 system communications protocol administered by the Operating System and Computing Platform 5. The vertical guidance partition (i.e. FMS₀) subsequently generates a modification command output comprising an instruction to modify the state of the connected aircraft control 2 (e.g. alter the position of a control surface) and thereby change the aircraft attitude. The modification command output is passed to the IO 7, which conditions and formats the modification command output appropriately for the media and communications protocol according to the ICD governing the interface with the connected aircraft control 2.

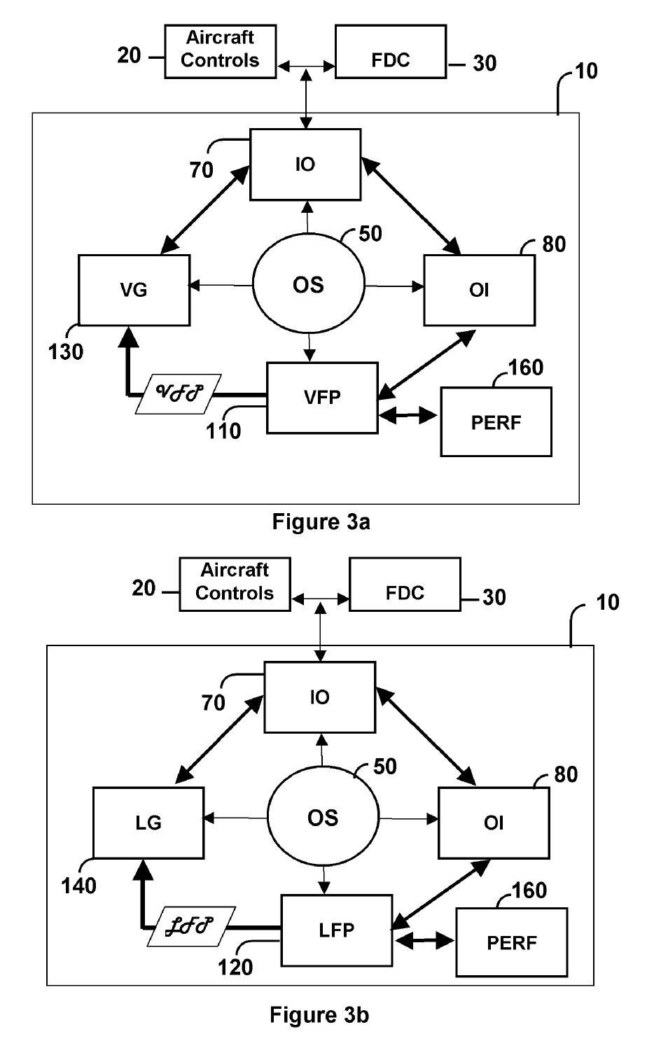

By way of further illustration, FIGS. 3a and 3b illustrate a preferred embodiment implementing the interfacing methodology described above. FMS 10 partitions are coupled through the IO 70 to aircraft systems such as the aircraft controls 20 (e.g. ailerons, elevators, rudders, and engine(s)) and Flight Deck Control (FDC) 30, whereas other partitions communicate only with other FMS 10 partitions. The IO 70 collects data from the aircraft controls 20 and FDC 30 using the appropriate communications protocol (e.g. ARINC Spec, MIL Spec, TCP, UDP, or other proprietary protocol(s)) as described by the ICD defining the respective interface and delivers data to the appropriate FMS 10 partition using the intra system communications media and protocol. Likewise, the IO 70 delivers data originating from other FMS 10 partitions and delivers that data to the aircraft control systems using the ICD defining the interface. The OI 80 interfaces with the IO 70 and collects data from the aircrew via a data entry device such as a keypad. The OI 80 also interfaces with the IO 70 to deliver data to the pilot on a FDC 30. Aircrew or pilot entries are routed via the IO 70 to the OI 80 for interpretation and if necessary, redirection, to the appropriate partition within the FMS 10 that is to operate on or incorporate that input data.

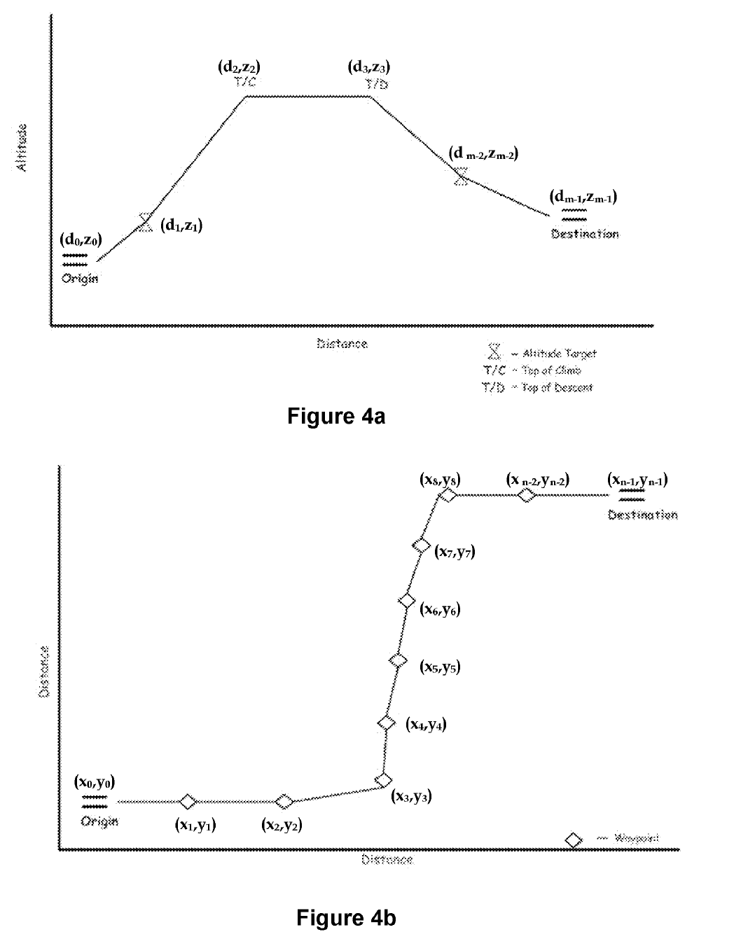

FIGS. 3a and 3b illustrate a preferred manner of flight planning implemented by the FMS 10 system architecture and design methodology described herein. Communications between FMS 10 partitions and aircraft controls is as described above. In the illustrated embodiment, the VFP 110 and LFP 120 operate independently of each other and produce a vertical flight plan data structure distinct from, and independent of, a lateral flight plan data structure for the VG 130 and LG 140, respectively. The PERF 160 calculates and provides data associated with the airframe and engine that is used by the VFP 110 and LFP 120 to generate the flight plans. As conveyed by FIG. 3a, the VG 130 calculates or derives vertical guidance targets based on the aircraft position relative to the vertical flight plan data structure (“VFP”) compiled or generated by the VFP 110 to generate outputs to aircraft controls 20 that guide and control the aircraft ascent, level flight, and descent. FIG. 4a illustrates a representative vertical flight plan data structure comprised of vertical guidance targets. The vertical flight plan comprises a data structure of data relevant to the plan for vertical guidance and control of the aircraft and includes a two-dimensional plane wherein two coordinates represent each vertical target in the vertical flight plan along with the data set representing specific characteristics about those points. More particularly, the vertical flight plan comprises a data structure including the set of coordinates comprising: [{(d₀, z₀, (d₁, z₁), . . . (dₘ₋₂, zₘ₋₂), (dₘ₋₁, zₘ₋₁)} where: d is a lateral distance reference on the flight path, and z is a altitude reference on the flight path].

Similarly, as shown in FIG. 3b, the LG 140 uses the lateral flight plan compiled or generated by the LFP 120 to derive guidance targets to generate outputs to aircraft controls 20 that guide and control the lateral or horizontal path of the aircraft. As conveyed by FIG. 3b, the LG 140 calculates or derives lateral guidance targets based on the aircraft position relative to the lateral flight plan data structure (“LFP”) derived from the LFP 120 to generate outputs to aircraft controls 20 that guide and control the aircraft horizontal or lateral direction. FIG. 4b illustrates a representative lateral flight plan comprised of lateral guidance targets. Each lateral target in the lateral flight plan is represented by two coordinates representing each lateral target in the lateral flight plan along with the data set representing specific characteristics about those points that exist on a two-dimensional plane that is preferably perpendicular or orthogonal to the two-dimensional plane represented by the vertical flight plan. More particularly, the lateral flight plan comprises a data structure of data relevant to the plan for the lateral guidance and control of the aircraft and includes a data structure including the set of coordinates comprising: [{(x₀, y₀, (x₁, y₁), . . . (xₘ₋₂, yₘ₋₂), (xₘ₋₁, yₘ₋₁)} where: x is a lateral distance reference on the flight path, and y is a lateral distance reference on the flight path]. Vertical or lateral guidance targets can be delivered to autopilot and flight directors for coupled or decoupled aircraft guidance assistance to the pilot. The intersection of the vertical flight plan and lateral flight plan defines the three-dimensional flight plan intended for the aircraft.

A common technique in traditional FMS architectures is to calculate or generate a single three-dimensional flight plan. The complexity of the calculations needed to calculate or generate a single three-dimensional flight plan places significant demands on FMS resources and ordinarily results in tightly coupled non cohesive data structures that cause system delays or a slogging down of the FMS. Further, it is common for the FMS to experience contention for resources and flight plan data as each FMS function waits for system resources so that it may operate on the new flight plan data.

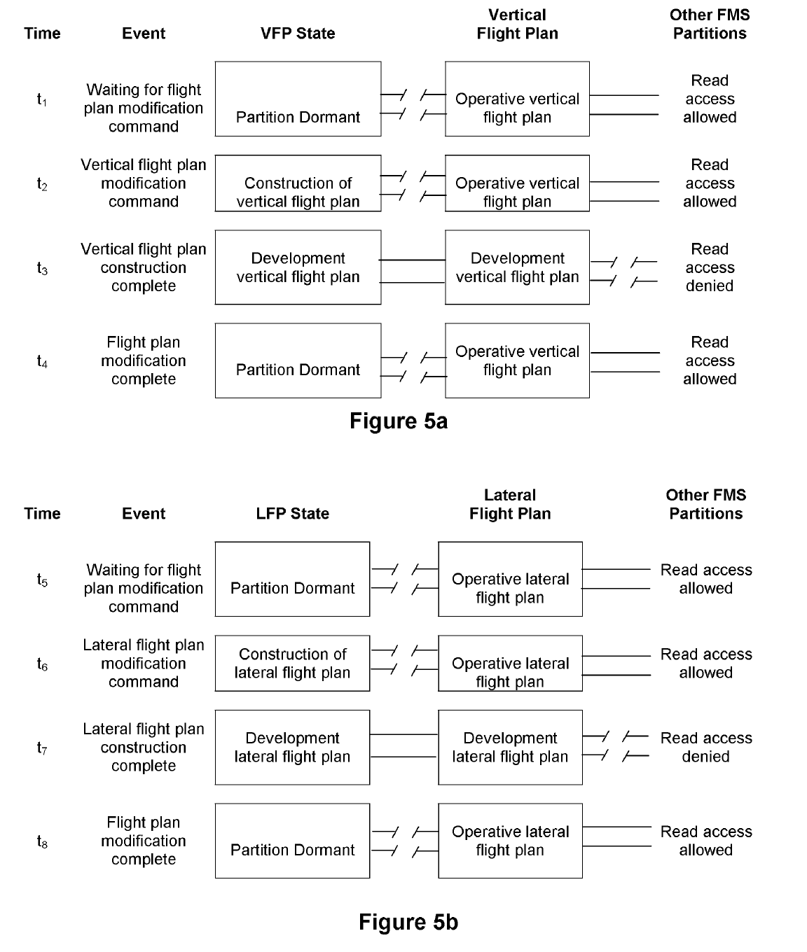

The preferred FMS 10 eliminates many of the problems associated with data or system resource contention by the instantiation of operative vertical and lateral flight plans and developmental vertical and lateral flight plans. The operative flight plans are data structures distributed to or accessible by the other FMS 10 partitions for aircraft control operations. The developmental flight plans are data structures generated in the VFP 110 and the LFP 120 and made accessible or available to the other FMS 10 partitions upon completion. FIG. 5a illustrates a representative timing diagram of vertical flight planning. At time t₁ the VFP 110 is dormant and an operative vertical flight plan data structure exists in FMS 10 system memory for read access by the other FMS partitions. At time t₂, the VFP 110 is given a command to construct or develop a new vertical flight plan. Beginning at time t₃, the VFP 110 completes development of the vertical flight plan; denies the other FMS partitions read access to the vertical flight plan; and updates system memory storing the vertical flight plan. Finally, at time t₄, the VFP 110 is dormant as at time ti. FIG. 5b likewise illustrates a representative timing diagram of lateral flight planning. At time t5, the LFP 120 is dormant and an operative lateral flight plan data structure exists in FMS 10 system memory for read access by the other FMS partitions. At time t₆, the LFP 120 is given a command to construct or develop a new lateral flight plan. Beginning at time t₇, the LFP 120 completes the development of the lateral flight plan; denies the other FMS partitions read access to the lateral flight plan; and updates system memory storing the lateral flight plan. At time t₈, the LFP 120 is dormant as at time t₅.

Additional FMS 10 partitions not shown in FIGS. 3a and 3b are described below with the understanding that each partition could be added to the FMS 10 without altering the system design methodology. For example, the PERF 160 is organized as a knowledge base package to serve the FMS 10 partitions. The PERF 160 performs calculations associated with airframe and engine related data, and collects and provides airframe and engine related data to the relevant FMS 10 partition for use in flight operations (e.g. flight planning, display). Some examples of data variables collected and provided to the other FMS 10 partitions are; Minimum/Maximum Speeds, Economy Speeds, Aircraft Gross Weight, Maximum Altitude, Optimum Altitude, Predictive Values etc. In the case of some of the variables described, data is generated within the PERF 160 and provided to a particular FMS 10 partition using procedures embedded within the PERF 160. Typical embedded procedures are called upon by the FMS 10 to provide the necessary, accurate calculations of data for use by the VFP 110 and the LFP 120 to create the Lateral Flight Plan and Vertical Flight Plan. Predictive information is that information used to best estimate the aircraft's situation at some time along the given flight regime in the future.

Further, rather than embedding specific airframe and engine related data in the PERF 160, the preferred FMS 10 will isolate said airframe and engine related data within an aero-engine database 165. Thus, the airframe and engine data is separated from the performance calculations and the PERF 160 can access the database to gather data to be used in performance calculations. Aircraft performance calculations are based on the laws of physics and are generic in nature and completely reusable when using the preferred method of isolating the aero-engine database. Therefore switching from one airframe-engine combination to a new combination becomes a function of defining a new aero-engine database 165 based on the characteristics of the new aircraft. Further, this means that the FMS 10 could be available earlier in the aircraft development program; helping to validate the planned performance characteristics of the aircraft design during development and flight test.

The NAV 150 determines the position of the aircraft in real time including but not limited to the aircraft latitude and longitude as well as aircraft altitude. Some sources used to accomplish this include, but are not limited to GPS data, radio tuning, magnetic variation, and aircraft velocity and wind velocity computations. The EIS 170 interfaces with Electronic Instrument System such as a ‘glass cockpit’ display system to annunciate FMS information to the flight crew. This includes, but is not limited to, presentation of waypoints and navigational aids, presentation of lateral legs, presentation of intercept points, etc . . . The EIS 170 reads data from the lateral flight plan and vertical flight plan to determine intercept points, distances, etc . . . and provides that display information to the pilot. The MAINT 180 provides data collection and reporting for any type of failure the FMS 10 is capable of detecting. This is to include hardware failures, software failures and detected failures of other aircraft systems. MAINT 180 provides exception-handling methods for FMS 10 software. Further, the concept of a non-critical exception can be introduced. The purpose of the non-critical exception handler would be to store information about the execution location of an event that, while not critical enough to reset the FMS 10 should be provided to a cognizant engineer. Using advanced communication technology, MAINT 180 information can be communicated in near real-time (as appropriate) for improved system quality in response to exception events. At a minimum, access to the maintenance information should be available to a maintenance terminal operated by a ground crew. The MAINT also provides maintenance activities such as data and program loading

Finally, the OS 50 provides a layer of administration to the FMS 10 and an interface to computing hardware and management of computing resources to other FMS partitions. The OS 50 has the primary responsibility of scheduling of partition tasks memory management and the apportionment and distribution of data between FMS 10 partitions. An exemplary task performed by the OS 50 is providing information or data from the PERF 160 to the OI 80. In one embodiment, the PERF 160 communicates to the OS 50 that “airspeed” data is available for the OI 80. The OS 50 then permits the PERF 160 to control computing resources and initiate the transmission of the “airspeed” data to the OI 80. In the case that the flight management architecture is distributed amongst physically distinct hardware devices, each device will contain an embedded OS.

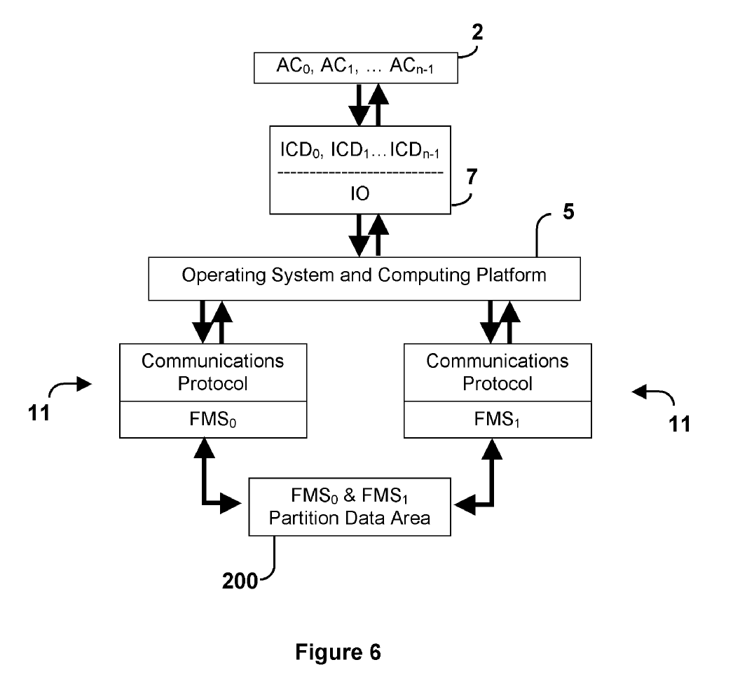

An additional and optional feature of preferred embodiment of an FMS 10 comprises the inclusion and use of partition data areas 200 to exchange data between partitions. FIG. 6 illustrates a conceptual model of a preferred FMS 10 architecture implementing a partition data area 200. The partition data area comprises specified memory or memory locations dedicated to specific FMS 10 partitions. The partition data area 200 can be embodied in physically distinct hardware or dynamically created and administered by the operating system and computing platform 5. In the model, the first partition 11 (FMS₀) and the second partition 11 (FMS₁) exchange or pass data using the partition data area 200. Thus, a data item or data structure generated by FMS₀ that is relevant to FMS₁, is written to the partition data area 200 for a read operation by FMS₁. Likewise, a data item or data structure generated by FMS₁ that is relevant to FMS₀, is written to the partition data area 200 for a read operation by FMS₀. In the example, a first partition 11 writes data to the partition data area 200 and alerts the second partition 11 of the write operation. The second partition subsequently reads the partition data area 200 according to control by the operating system and computing platform control 5. If the partition data data area 200 is static, the communication of the presence of data within the partition data area 200 may be a setting of one or more bits in a register or memory location that is polled by the recipient FMS 10 partition. Otherwise the communication of the presence of the data within the partition data area 200 may also include the exact location of the data in the system memory as communicated via the operating system and computing platform 5. A partition data area description specifies operational boundaries for data to be written within a partition data area 200 describing the quantity, type of, and format of data that may be written to the partition data area 200.

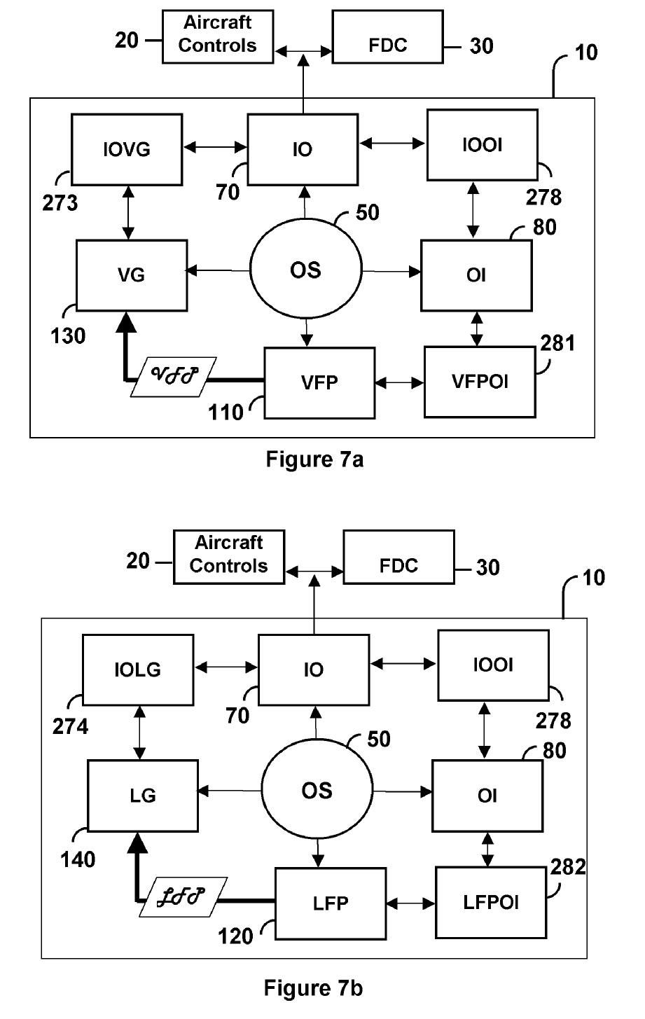

FIG. 7a illustrates further detail of a preferred implementation of partition data areas for vertical flight planning and aircraft control. The OI 80 and VFP 110 have read and write access to a VFPOI partition data area 281 used to exchange only that data relevant to both the OI 80 and VFP 110. Exemplary information relevant to the OI 80 and VFP 110 includes information entered from the aircrew to be used for vertical flight planning. Because this data is not used by other partitions, the OI 80 writes data to the VFPOI partition data area 281 and communicates to the VFP 110 the presence of the data. The VFP 110 reads the VFPOI partition data area 281 and operates on the data for incorporation into the flight plan. Likewise, the VFP 110 may write data intended only for the OI 80 to the VFPOI partition data area 281, which may be read by the OI 80. FIG. 7a also illustrates the use of an IOVG partition data area 273 used with the IO 70 and VG 130 to communicate vertical aircraft guidance commands to the aircraft controls 20. An IOOI partition data area 278 is used to exchange data between the OI 80 and the IO 70.

FIG. 7b illustrates further detail of a preferred implementation of partition data areas for lateral flight planning and aircraft control. The OI 80 and LFP 120 have read and write access to a LFPOI partition data area 282 used to exchange data relevant to both the OI 80 and LFP 120 such as information entered from the aircrew to be used for lateral flight planning. Because this data is not used by other partitions, the OI 80 writes data to the LFPOI partition data area 282 and communicates to the LFP 120 the presence of the data. The LFP 120 reads the LFPOI partition data area 282 and operates on the data. Likewise, the LFP 120 may write data intended only for the OI 80 to the LFPOI partition data area 282, which may be read by the OI 80. FIG. 7b also illustrates the use of an IOLG partition data area 274 used with the IO 70 and LG 140 to communicate lateral aircraft guidance commands to the aircraft controls 20. Alternate partition data areas are also contemplated for inclusion in alternate embodiments and the implementation of said alternate partition data areas would be within the ordinary skill of a person in the art given the disclosure herein.

Although the invention has been described in detail with reference to particular preferred embodiments, persons possessing ordinary skill in the art to which this invention pertains will appreciate that various modifications and enhancements may be made without departing from the spirit and scope of the claims that follow.

What is claimed is:

1. A flight management system, comprising:
an operating system on a computing platform that interfaces with,
a lateral flight planning partition that constructs a lateral flight plan of waypoints within a first two-dimensional plane, and
a vertical flight planning partition that constructs a vertical flight plan of waypoints within a second two-dimensional plane.

2. The flight management system in claim 1 wherein,
the lateral flight planning partition comprises a lateral flight planning algorithm that executes upon lateral flight data.

3. The flight management system in claim 1 wherein,
lateral flight data comprises data originating from a navigation database and data originating from an operator input device.

4. The flight management system in claim 1 wherein,
the lateral flight planning algorithm comprises at least one of a variety of executable algorithms selected from the group consisting of, predictive algorithms and performance algorithms.

5. The flight management system in claim 1 wherein,
the lateral flight planning partition grants a lateral guidance partition read-only access to the lateral flight plan.

6. The flight management system in claim 1 wherein,
the vertical flight planning partition includes a vertical flight planning algorithm that executes upon vertical flight data.

7. The flight management system in claim 6 wherein,
vertical flight data comprises data originating from a navigation database and data originating from an operator input device.

8. The flight management system in claim 1 wherein,
the vertical flight planning algorithm comprises at least one of a variety of executable algorithm selected from the group consisting of, predictive algorithms and performance algorithms.

9. The flight management system in claim 1 wherein,
the vertical flight planning partition grants a vertical guidance partition read-only access to the vertical flight plan.

10. In a flight management system comprised of computer memory and an operating system operating on a computing platform, a method of managing computer memory comprising:
restricting the read and write privileges to a portion of computer memory to a first and second flight management system functions selected from the group of functions consisting of, input and output, aircraft guidance, operator input device handling, aircraft performance, airframe and aero engine database, and flight planning.

11. The memory management architecture in claim 10 wherein,
the first flight management system function is a flight planning partition and the second flight management system function is a flight guidance partition.

12. The memory management architecture in claim 11 wherein,
the flight planning partition comprises a partition selected from the group consisting of, a lateral flight planning partition and a vertical flight planning partition, and
the flight guidance partition is selected from the group consisting of a lateral guidance partition and a vertical guidance partition.

13. The memory management architecture in claim 12 wherein, the flight planning partition further comprises a first data structure comprising a developmental flight plan and a second data structure comprising an operative flight plan.

14. The memory management architecture in claim 10 wherein,
the first flight management system function comprises an aircraft performance function and the second flight management system function comprises an aero engine database.

15. The memory management architecture in claim 14 wherein,
the aircraft performance function comprises aircraft performance algorithms.

16. A method of developing a flight plan in a flight management system, comprising:
permitting software functions within the flight management system access to flight data within a previously developed first flight plan; while
denying software functions within the flight management system access to flight data within a second flight plan undergoing development, and subsequently,
permitting software functions within the flight management system access to flight data within the second flight plan upon its completion.

17. The method of claim 16 wherein,
the first flight plan and second flight plan are comprised of coordinates on a two-dimensional plane.

18. The method of claim 16 further comprising,
permitting software functions within the flight management system access to flight data within a previously developed third flight plan; while
denying software functions within the flight management system access to flight data within a fourth flight plan undergoing development, and subsequently,
permitting software functions within the flight management system access to flight data within the fourth flight plan upon its completion.

19. The method of claim 18 wherein,
the first flight plan and second flight plans are comprised of coordinates on first two-dimensional plane and the third flight plan and fourth flight plans are comprised of coordinates on a second two-dimensional plane.
